(19) United States
(12) Patent Application Publication
(10) Pub. No.: US 2025/0332655 A1
(43) Pub. Date: Oct. 30, 2025

(54) FRICTION STIR SPOT WELDING DEVICES WITH BACKFILLING

(71) Applicant: ANHUI WORLD WIDE WELDING CO., LTD., Hefei (CN)

(72) Inventors: Xi SHU, Hefei (CN); Long WAN, Hefei (CN); Zhekai ZHU, Hefei (CN)

(73) Assignee: ANHUI WORLD WIDE WELDING CO., LTD., Hefei (CN)

(21) Appl. No.: 19/238,320

(22) Filed: Jun. 13, 2025

Related U.S. Application Data
(63) Continuation-in-part of application No. PCT/CN2024/076247, filed on Feb. 6, 2024.

(30) Foreign Application Priority Data
Dec. 13, 2022 (CN) 202211601088.3
Dec. 13, 2022 (CN) 202211604687.0

(51) Int. Cl. B23K 20/12

(52) U.S. Cl. CPC B23K 20/12

(57) ABSTRACT

The present disclosure relates to a refill friction stir spot welding device. The refill friction stir spot welding device includes: a stir pin assembly including a stir pin; a stir sleeve assembly including a stir sleeve, the stir sleeve being sleeved outside the stir pin, the stir sleeve having a same axis as the stir pin; and an axial drive assembly and a rotary drive assembly, the axial drive assembly driving the stir pin and the stir sleeve, respectively, to move along the axis, the rotary drive assembly driving the stir pin and the stir sleeve to perform a rotational motion centered on the axis, a center axis of the axial drive assembly and a rotary axis of the rotary drive assembly are both located on the axis.

### CROSS-REFERENCE TO RELATED APPLICATIONS

This application is a continuation-in-part of International Patent Application No. PCT/CN2024/076247, filed Feb. 6, 2024, which claims priority to Chinese Patent Application No. 202211601088.3, filed Dec. 13, 2022, and priority to Chinese Patent Application No. 202211604687.0, filed Dec. 13, 2022, the entire contents of each of which are hereby incorporated by reference.

### TECHNICAL FIELD

This present disclosure relates to the technical field of friction stir spot welding, and in particular, relates to a refill friction stir spot welding device.

### BACKGROUND

Friction stir spot welding is a novel solid-state welding technology developed based on friction stir welding technology. The friction stir spot welding technology produces lap joints similar to those made by resistance spot welding and riveting, and offers advantages such as high joint quality, stable welding quality, minimal deformation, and high energy efficiency. The friction stir spot welding technology effectively compensates for the defects associated with resistance spot welding and riveting. Refill friction stir spot welding (also referred to as backfill friction stir spot welding) technology has successfully solved the problem of leaving a keyhole in the center of the welding point after conventional friction stir spot welding is completed.

In the process of spot welding, it is necessary to accurately control the displacement and pressure changes of the stir pin. However, current displacement adjustment manners that use a side-shaft drive generate a bending moment, leading to a loss of the accuracy of the welding position. The passive displacement adjustment manner requires the use of a pressure sensor for feedback adjustment, which can lead to hysteresis problems.

Therefore, it is necessary to provide a refill friction stir spot welding device with high control accuracy.

### SUMMARY

One or more embodiments of the present disclosure provide a refill friction stir spot welding device comprising: a stir pin assembly including a stir pin; a stir sleeve assembly including a stir sleeve, the stir sleeve being sleeved outside the stir pin, the stir sleeve having a same axis as the stir pin; and an axial drive assembly and a rotary drive assembly, the axial drive assembly driving the stir pin and the stir sleeve, respectively, to move along the axis, the rotary drive assembly driving the stir pin and the stir sleeve to perform a rotational motion centered on the axis, a center axis of the axial drive assembly and a rotary axis of the rotary drive assembly are both located on the axis.

One or more embodiments of this present disclosure provide a welding system. The welding system comprises two refill friction stir spot welding devices, a processing unit, and two robotic arms, and the two refill friction stir spot welding devices are respectively mounted on the two robotic arms. The two refill friction stir spot welding devices have different rotary drive assemblies, and/or the two refill friction stir spot welding devices have different axial drive assemblies; and the processing unit is configured to: determine a target robotic arm based on a historical welding quality, a material property, and dimensional information of a workpiece to be welded, and control the target robotic arm to weld the workpiece to be welded.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a refill friction stir spot welding device according to some embodiments of the present disclosure;

FIG. 2 is a schematic diagram illustrating a structure of a refill friction stir spot welding device according to some embodiments of the present disclosure;

FIG. 3 is an enlarged schematic diagram of region A according to some embodiments of the present disclosure;

FIG. 4 is a schematic diagram illustrating a structure of a portion of a refill friction stir spot welding device according to some embodiments of the present disclosure;

FIG. 5 is a schematic diagram illustrating another structure of a refill friction stir spot welding device according to some embodiments of the present disclosure;

FIG. 6 is a schematic diagram illustrating another structure of a refill friction stir spot welding device according to some embodiments of the present disclosure;

FIG. 7 is an enlarged schematic diagram of region B according to some embodiments of the present disclosure;

FIG. 8 is a schematic diagram illustrating another structure of a portion of a refill friction stir spot welding device according to some embodiments of the present disclosure;

FIG. 9 is a schematic diagram illustrating another structure of a refill friction stir spot welding device according to some embodiments of the present disclosure;

FIG. 10 is a schematic diagram illustrating a section of a refill friction stir spot welding device according to some embodiments of the present disclosure;

FIG. 11 is a flowchart of an exemplary process for determining a welding quality based on a quality model according to some embodiments of the present disclosure; and

FIG. 12 is a schematic diagram illustrating a structure of a welding system according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

During a process of spot welding, in order to achieve precise welding, it is necessary to accurately control the displacement and pressure changes of a stir pin. Due to constraints in available installation space and challenges in structural design, most current implementations utilize either a side-shaft driving manner for displacement adjustment or realize a passive displacement adjustment by employing spring-like elastic components. However, the side-shaft driving manner may generate bending moments, resulting in a loss of the accuracy of the welding position, while passive displacement adjustment requires feedback adjustment using pressure sensors, which has a lag problem.

In view of the foregoing, some embodiments of the present disclosure provide a refill friction stir spot welding device that drives the movement of both the stir pin and the stir sleeve through a coaxial control. The device has a compact structure, effectively resolving the bending moment issue associated with the side-shaft driving manners and achieving high welding precision.

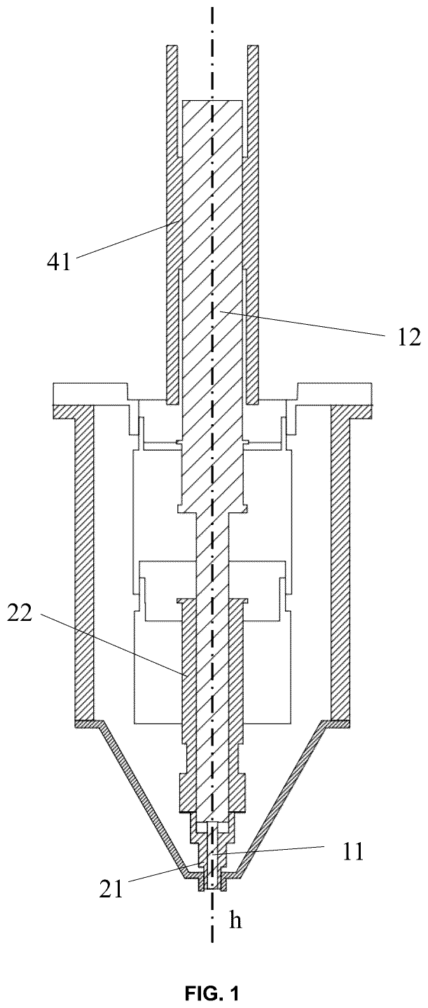

FIG. 1 is a schematic diagram illustrating a refill friction stir spot welding device according to some embodiments of the present disclosure.

In some embodiments, as shown in FIG. 1, the refill friction stir spot welding device includes a stir pin assembly, a stir sleeve assembly, an axial drive assembly, and a rotary drive assembly. In some embodiments, the stir pin assembly includes a stir pin 11, the stir sleeve assembly includes a stir sleeve 21, the stir sleeve 21 is provided outside the stir pin 11, and the stir sleeve 21 has the same axis h as the stir pin 11. In some embodiments, the axial drive assembly may drive the stir pin 11 and the stir sleeve 21, respectively, to move along the axis h, and the rotary drive assembly drives the stir pin 11 and the stir sleeve 21 to perform a rotational motion centered on the axis h. The center axis of the axial drive assembly and the rotary axis of the rotary drive assembly are both located on the axis h.

The stir pin assembly is a combination of parts used to achieve spot welding.

In some embodiments, the stir pin assembly may include the stir pin 11.

The stir pin 11 refers to a component that stirs the surface of a workpiece, generates heat through friction, and achieves spot welding. In some embodiments, the stir pin 11 can rotate around the axis h as the center, that is, the axis h is the rotational axis of the stir pin 11, so that the stir pin 11 can stir the workpiece. In some embodiments, the stir pin 11 may be a columnar structure, and the axis h may be the center axis of the columnar structure of the stir pin 11. In some embodiments, the stir pin 11 may be a high-temperature wear-resistant material, such as alloy steel.

In some embodiments, the stir pin assembly may include a stir pin shaft 12.

The stir pin shaft 12 is used to transmit power to the stir pin 11. In some embodiments, the stir pin shaft 12 can rotate around the axis h as the center, that is, the axis h is the rotational axis of the stir pin shaft 12. In some embodiments, the stir pin shaft 12 may be a rod-like structure, and the axis h may be the center axis of the stir pin shaft 12. In some embodiments, the material of the stir pin shaft 12 may be a rigid material with high strength, such as high-strength steel.

In some embodiments, the stir pin shaft 12 may be fixedly connected to the stir pin 11, and a rotational axis of the stir pin shaft 12 and a rotational axis of the stir pin 11 are located on the axis h. In some embodiments, when the stir pin shaft 12 is rotated, the stir pin 11 can be synchronized to undergo coaxial rotation.

In some embodiments, the stir pin shaft 12 may be fixedly connected to the stir pin 11.

In some embodiments, the stir pin shaft 12 and the stir pin 11 may be fixedly connected by a first cooperating structure and a second cooperating structure. The stir pin shaft 12 may be provided with the first cooperating structure, and the stir pin 11 may be provided with the second cooperating structure. The first cooperating structure is a position-limiting structure provided on the stir pin shaft 12. The second cooperating structure is a position-limiting structure provided on the stir pin 11 that cooperates with the first cooperating structure. The first cooperating structure cooperates with the second cooperating structure to restrict a relative motion between the stir pin shaft 12 and the stir pin 11. The relative motion includes a rotational relative motion and a relative motion along the axis h. It is to be understood that by the cooperation between the first cooperating structure and the second cooperating structure, it is possible to restrict the relative motion between the stir pin shaft 12 and the stir pin 11, but not the synchronized movement of the stir pin shaft 12 and the stir pin 11. That is to say, the stir pin shaft 12 and the stir pin 11 are unable to rotate relative to each other, and are only able to rotate together centered on the axis h. At the same time, the stir pin shaft 12 and the stir pin 11 are unable to undergo a relative motion along the axis h, and are only able to synchronize move along the axis h.

In some embodiments, the first cooperating structure may include a cylindrical groove formed at a bottom of the stir pin shaft 12. The second cooperating structure may include a rectangular structure disposed at a top end of the stir pin 11, and the rectangular structure is capable of being embedded into the cylindrical groove to restrict a rotational relative motion between the stir pin 11 and the stir pin shaft 12. The first cooperating structure or the second cooperating structure also includes a lock nut, which locks and secures the stir pin 11 and the stir pin shaft 12 to restrict a relative motion between the stir pin 11 and the stir pin shaft 12 along the axis h.

In some embodiments, the first cooperating structure may include a cruciform hole formed at the bottom of the stir pin shaft 12. The second cooperating structure may include a cruciform structure disposed at the top end of the stir pin 11, and the cruciform structure is capable of being embedded into the cruciform hole to restrict the rotational relative motion between the stir pin 11 and the stir pin shaft 12. The first cooperating structure or the second cooperating structure further includes a lock nut, which locks and secures the stir pin 11 and the stir pin shaft 12 to restrict the relative motion between the stir pin 11 and the stir pin shaft 12 along the axis h. The cooperation connection through the cruciform structure, the torsional stiffness is high, and it is not prone to eccentricity.

In some embodiments, the first cooperating structure includes a tapered hole disposed at the bottom of the stir pin shaft 12. The second cooperating structure includes a tapered structure disposed at the top end of the stir pin 11, and the stir pin shaft 12 and the stir pin 11 are fixedly assembled by interference fit via the tapered hole and the tapered structure to restrict the relative motion between the stir pin shaft 12 and the stir pin 11. Fixing by the interference fit does not require an additional lock nut for fixing, and the tapered connection is not prone to eccentricity.

In some embodiments, the first cooperating structure and the second cooperating structure may also be provided with other feasible structures to achieve a fixed connection between the stir pin shaft 12 to the stir pin 11 and to restrict the relative motion between the stir pin shaft 12 and the stir pin 11.

The stir sleeve assembly is a combination of components used to protect the stir pin assembly. In some embodiments, backfilling of a keyhole formed during the welding process can be achieved via the cooperation of the stir sleeve assembly with the stir pin assembly.

The stir pin and the stir sleeve can both be used for welding and for backfilling, both functions are available. However, one of the stir pin and the stir sleeve is used for insertion while the other is used for backfilling. In the same scenario, the two functions are opposite. For example, during a first welding operation, the stir pin is inserted for welding while the stir sleeve is provided for backfilling, and during a second welding operation, the stir sleeve is inserted for welding while the stir pin is provided for backfilling.

In some embodiments, the stir sleeve assembly may include a stir sleeve 21.

The stir sleeve 21 is a component for protecting the stir pin 11. The stir sleeve 21 may be sleeved outside the stir pin 11 to form a wrapping around the lower end of the stir pin 11 to ensure that the stir pin 11 does not bend under stress. In some embodiments, the stir sleeve 21 may have a hollow cylindrical structure, and the axis h may be the center axis of the stir sleeve 21. In some embodiments, the material of the stir sleeve 21 may be a high-temperature wear-resistant material, such as alloy steel.

In some embodiments, the stir sleeve assembly may include a stir sleeve shaft 22.

The stir sleeve shaft 22 is used to transmit power to the stir sleeve 21. The stir sleeve shaft 22 may be a hollow rod-like structure, and the axis h may be the center axis of the stir sleeve shaft 22. In some embodiments, the material of the stir sleeve shaft 22 may be a rigid material with high strength, such as high-strength steel.

In some embodiments, the stir sleeve shaft 22 may rotate centered on axis h, i.e., the axis h is the rotational axis of the stir sleeve shaft 22. A rotational axis of the stir sleeve shaft 22 and a rotational axis of the stir pin shaft 12 are located on the axis h. The stir sleeve shaft 22 and the stir pin shaft 12 are capable of undergoing a relative motion along the axis h. The stir sleeve shaft 22 and the stir pin shaft 12 are in a rotation-locked engagement state, meaning that they cannot rotate relative to each other but can only rotate synchronously.

In some embodiments, the stir sleeve shaft 22 and the stir pin shaft 12 may be connected in any feasible manner. For example, the stir sleeve shaft 22 may be sleeve-connected to the outer side of the stir pin shaft 12 via a spline. The spline may be a rectangular spline, an involute spline, a rolling spline, or the like. In some embodiments, the stir sleeve shaft 22 and the stir pin shaft 12 are connected by a spline can further enhance the precision of the connecting structure while reducing noise.

In some embodiments, the stir sleeve shaft 22 may be fixedly connected to the stir sleeve 21. The stir sleeve shaft 22 may be fixedly connected to the stir sleeve 21 in any feasible manner. For example, the stir sleeve shaft 22 and the stir sleeve 21 may be fixedly connected by a spline nut 23. Through the fixed connection, the stir sleeve shaft 22 and the stir sleeve 21 can be synchronized for rotational motion as well as synchronized for motion along the axis h.

The rotary drive assembly is configured to drive the stir pin 11 and the stir sleeve 21 to perform a rotational motion around the axis h as the center. In some embodiments, the rotary drive assembly has a rotary axis (or a rotational axis). The rotary axis of the rotary drive assembly can be considered to be the center of rotation of the rotary drive assembly, and the rotary drive assembly is capable of rotating around the rotary axis. The rotary axis of the rotary drive assembly is located on axis h. For example, the rotary drive assembly is an electric spindle, a mechanical spindle, an electric motor, or the like.

In some embodiments, the rotary drive assembly may include an electric spindle. The electric spindle is a component that provides rotational torque via an electrical power source. The electric spindle may be located at an upper portion of an outer casing 60 and fixedly connected to the outer casing 60, e.g., the electric spindle and the outer casing 60 may be bolted.

In some embodiments, a core shaft 41 is disposed in the electric spindle. The core shaft 41 is a component for transmitting rotational torque. The core shaft 41 may be fixedly disposed in the middle of the electric spindle.

In some embodiments, the core shaft 41 may be a hollow column. The axis h may be a rotational axis of the core shaft 41, and the core shaft 41 may be rotated with the axis h as the center. The core shaft 41 may be sleeved outside the stir pin shaft 12. The rotational axis of the core shaft 41 and the rotational axis of the stir pin shaft 12 are located on the axis h, the core shaft 41 and the stir pin shaft 12 can perform a relative motion along the axis h, and the core shaft 41 and the stir pin shaft 12 are in a rotation-locked engagement state.

For example, a spline may be disposed at the top of the stir pin shaft 12, and a spline groove may be provided on an inner wall of the core shaft 41. The core shaft 41 may be connected to the stir pin shaft 12 via the spline, thereby allowing the relative motion between the core shaft 41 and the stir pin shaft 12 along a direction of the axis h without relative rotation to each other. More descriptions regarding the spline may be found in the related descriptions above.

In some embodiments, when the core shaft 41 rotates, it can drive the stir pin shaft 12 to rotate synchronously. The stir pin shaft 12 can then drive the stir pin 11 to rotate synchronously, thereby achieving the torque transmission.

The axial drive assembly is configured to drive the stir pin 11 and the stir sleeve 21 along the axis h. In some embodiments, the axial drive assembly has a center axis. The center axis of the axial drive assembly may be regarded as a central axis of the axial drive assembly along its extension direction, which is located at the center of the physical structure of the axial drive assembly. The center axis of the axial drive assembly may be regarded as a power output shaft of the axial drive assembly. This power output shaft may not have an actual physical structure. For example, the axial drive assembly may output power via a hollow column along an extension direction of the hollow column, in which case, the power output shaft may be the central axis of the hollow column. The center axis of the axial drive assembly is located on the axis h.

In some embodiments, the axial drive assembly may drive the stir pin 11 and the stir sleeve 21 along the axis h via various driving manners. The driving manners may include at least one of electric driving or hydraulic driving. More descriptions regarding the axial drive assembly may be found in the related descriptions below.

In some embodiments, power is supplied to the rotary drive assembly and the axial drive assembly. The rotary drive assembly drives the stir pin 11 and the stir sleeve 21 to rotate, and the axial drive assembly drives the stir pin 11 and the stir sleeve 21 to move upward and downward along the axis h, respectively, to realize backfill stirring friction spot welding. When welding, a preset pressure-displacement relationship can be used to coordinate the control of the stir pin 11 and the stir sleeve 21, thereby achieving precise welding.

In some embodiments, by coaxially setting the stir pin assembly, the stir sleeve assembly, the axial drive assembly, and the rotary drive assembly, the stir pin 11 and the stir sleeve 21 are capable of undergoing rotation centered on the axis h and motion along the axis during the welding process. In addition, the drive source is arranged coaxially with the stir pin 11 and the stir sleeve 21. This configuration overcomes the bending moment problem associated with the side-shaft drive, ensures rigidity of the system during welding, avoids hysteresis problems, and improves welding accuracy.

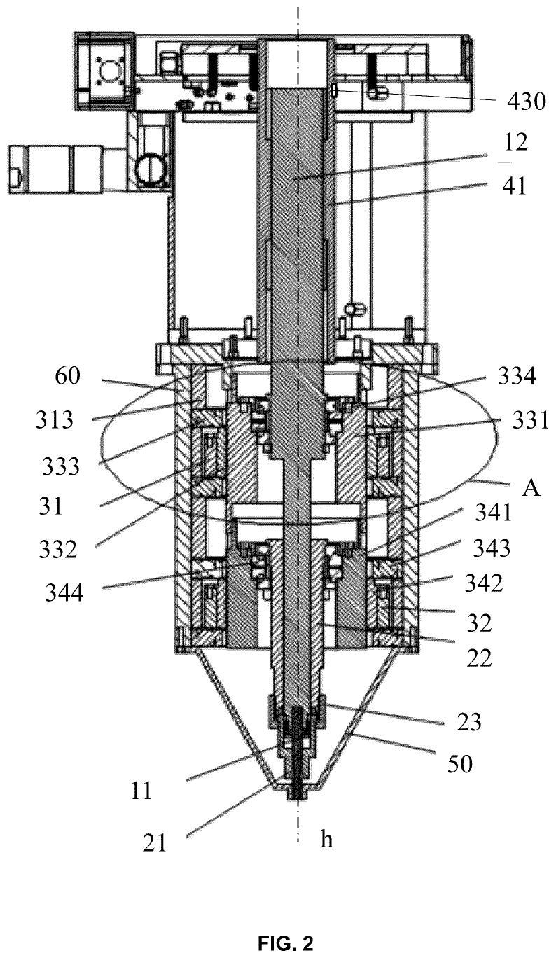

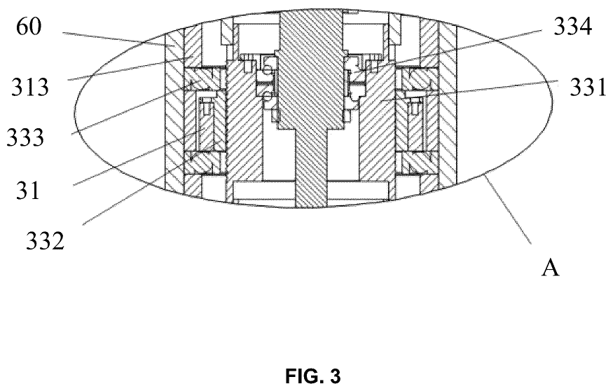

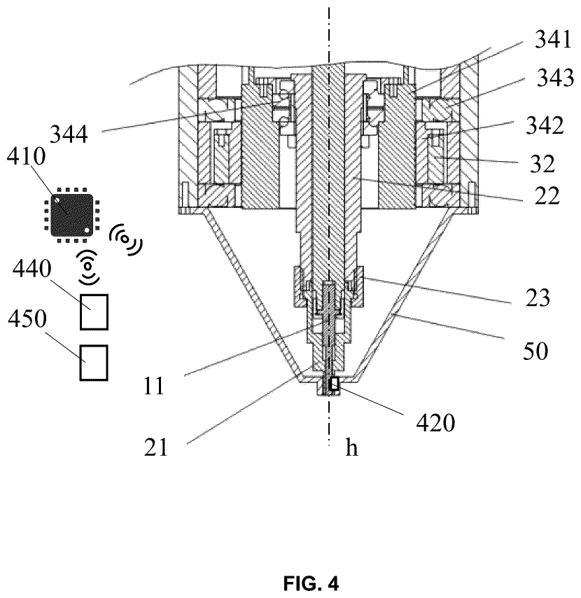

FIG. 2 is a schematic diagram illustrating a structure of a refill friction stir spot welding device according to some embodiments of the present disclosure. FIG. 3 is an enlarged schematic diagram of region A according to some embodiments of the present disclosure. FIG. 4 is a schematic diagram illustrating a structure of a portion of a refill friction stir spot welding device according to some embodiments of the present disclosure.

In some embodiments, the axial drive assembly includes at least one hollow motor, as shown in FIG. 2.

The hollow motor is a motor configured to provide a power source for movement along the axis h. The hollow motor has a hollow structure that may be sleeved on the outside of at least one of the stir sleeve assembly and the stir pin assembly.

In some embodiments, a center shaft of the hollow motor may be located on the axis h. The center shaft of the hollow motor may be located in a cavity within the hollow motor.

In some embodiments, the hollow motor may drive at least one of the stir pin shaft 12 or the stir sleeve shaft 22 along the axis h via a lead screw transmission assembly. Merely by way of example, when the hollow motor is in operation, a rotor of the hollow motor may be subjected to a rotational motion, which may be converted to a motion along the axis h by the lead screw transmission assembly, so as to drive at least one of the stir pin shaft 12 or the stir sleeve shaft 22 to enable movement along the axis h.

More descriptions regarding the lead screw transmission assembly may be found in the related descriptions below.

In other embodiments, the hollow motor may alternatively be replaced with an ordinary motor (e.g., a servo motor). The ordinary motor is connected to a master wheel. The master wheel drives a follower wheel through a drive belt. The follower wheel drives the lead screw transmission assembly, which converts the rotational motion into a motion along the axis h. This conversion causes at least one of the stir pin shaft 12 and the stir sleeve shaft 22 to move along the axis h.

In some embodiments, as shown in FIG. 2, the hollow motor may include a first hollow motor 31 and a second hollow motor 32. The first hollow motor 31 and the second hollow motor 32 may be coaxially provided in the direction of the axis h.

In some embodiments, the first hollow motor 31 drives the stir pin shaft 12 along the axis h through a first set of the lead screw transmission assembly, and the second hollow motor 32 drives the stir sleeve shaft 22 along the axis h through a second set of the lead screw transmission assembly.

The lead screw transmission assembly is an assembly that converts a rotational motion into a linear motion. In some embodiments, the lead screw transmission assembly includes a lead screw and a lead screw nut. The lead screw and the lead screw nut are drive-connected, for example, driving by the threaded engagement. The lead screw transmission assembly can utilize the thread engagement between the lead screw and the lead screw nut for transmission, so as to achieve linear motion by rotating the lead screw.

In some embodiments, the lead screw nut is connected to the rotor of the at least one hollow motor. At least one of the stir pin shaft 12 and the stir sleeve shaft 22 is rotatably connected to the lead screw, and a relative motion between the lead screw and at least one of the stir pin shaft 12 or the stir sleeve shaft 22 along the axis h is locked.

In some embodiments, there are many ways to connect at least one of the stir pin shaft 12 and the stir pin shaft 22 to the lead screw, such as fixing by a lock nut. The lead screw may be sleeved on an outside of at least one of the stir pin shaft 12 and the stir sleeve shaft 22.

The first hollow motor 31 and the second hollow motor 32 are taken as examples for further description. It should be noted that the following is only a feasible embodiment, but not a limitation. Understandably, a mounting position of the hollow motor and a connection way can be set as desired. For example, a mounting position of the first hollow motor 31 and a mounting position of the second hollow motor 32 may be interchanged. As another example, the first hollow motor 31 and the second hollow motor 32 may be connected to the stir pin shaft 12 and the stir sleeve shaft 22, respectively, through a plurality of feasible connection structures to realize the driving effect.

Merely by way of example, as shown in FIG. 2, FIG. 3, and FIG. 4, the first hollow motor 31 is drive-connected to a first set of the lead screw transmission assembly, and the second hollow motor 32 is drive-connected to a second set of the lead screw transmission assembly. The first set of the lead screw transmission assembly includes a lead screw 331 and a lead screw nut 332, and the second set of the lead screw transmission assembly includes a lead screw 341 and a lead screw nut 342.

The first hollow motor 31 is disposed on the outer casing 60 near an upper position, and first rolling bearings 333 (such as angular contact bearings, self-aligning ball bearings, tapered roller bearings, or self-aligning roller bearings, etc.) are disposed on both upper and lower sides of the first hollow motor. First spacer sleeves 313 are fixedly abutted against both sides of the first rolling bearings 333, and outer rings of the first rolling bearings 333 limit a stator of the first hollow motor 31 along the direction of the axis h. A rotor of the first hollow motor 31 is fixedly connected to a lead screw nut 332 of the first set of the lead screw transmission assembly, inner rings of the first rolling bearings 333 limit the lead screw nut 332 along the direction of the axis h.

The lead screw 331 is sleeved on an outer side of the stir pin shaft 12, and the lead screw 331 and the stir pin shaft 12 are connected via a second rolling bearing 334, which may be a thrust bearing. A first bearing cover and a first bearing lock nut are respectively disposed above and below the second rolling bearing 334. The first bearing cover and the first bearing lock nut can restrict a limit position of the movement of the lead screw 331 and the stir pin shaft 12 along the axis h, but do not affect the relative rotation between the stir pin shaft 12 and the lead screw 331.

When the first hollow motor 31 starts, its rotor rotates and drives the lead screw nut 332, which is fixedly connected to the rotor, to rotate. The lead screw nut 332 rotates without moving along the axis h, while the lead screw 331 is prevented from rotating. Under the rotation of the lead screw nut 332, the lead screw 331 is forced to move only along the axis h, thereby driving the stir pin shaft 12 to move along the axis h, and the stir pin 11, fixedly connected to the lower portion of the stir pin shaft 12, moves along the axis h accordingly.

The second hollow motor 32 is installed inside the outer casing 60 near the lower portion. A portion of a rotor of the second hollow motor 32 is fixedly connected to a lead screw nut 342, and a lead screw 341 is threadedly connected to an inner side of the lead screw nut 342. In this configuration, the rotor of the second hollow motor 32 connects to the lead screw 341 via the lead screw nut 342. Third rolling bearings 343 (such as angular contact bearings, self-aligning ball bearings, tapered roller bearings, or self-aligning roller bearings) are arranged on both the upper and lower sides of the second hollow motor 32. Outer rings of the third rolling bearings 343 limit a stator of the second hollow motor 32 along the direction of the axis h, while inner rings of the third rolling bearings 343 limit the lead screw nut 342 along the direction of the axis h.

The lead screw 341 is sleeved on an outer side of the stir sleeve shaft 22, and the lead screw 341 and the stir sleeve shaft 22 are connected via a fourth rolling bearing 344. The fourth rolling bearing 344 may be a thrust bearing. A second bearing cover and a second bearing lock nut are respectively disposed above and below the fourth rolling bearing 344. The second bearing cover and the second bearing lock nut can restrict the limit positions of the movement of the lead screw 341 and the stir sleeve shaft 22 along the axis h, but do not affect the relative rotation between the stir sleeve shaft 22 and the lead screw 341.

When the second hollow motor 32 is started, its rotor rotates and drives the lead screw nut 342, which is fixedly connected to the rotor, to rotate. The lead screw nut 342 rotates without moving along the axis h, while the lead screw nut 342 is engaged with the lead screw 341 through threaded for transmission. The lead screw 341 is prevented from rotating and, consequently, can only move along the axis h, thereby further driving the stir sleeve shaft 22 to move along the axis h.

In some embodiments, the refill friction stir spot welding device may include a control system. A control program for the pressure-displacement relationship may be embedded in the control system to control two hollow motors. This configuration enables precise control of the welding process.

In some embodiments, a compact and ingenious structure is achieved by the cooperation between two hollow motor drives and an electric spindle. With this configuration, the system exhibits high stability, welding precision is ensured, the welding quality is excellent, the service life of the entire welding device is extended, and a wide application range is obtained. The device is suitable for friction stir welding devices of dynamic shoulder and static shoulder types, as well as gantry-type, robotic arm-type, and other friction stir spot welding devices.

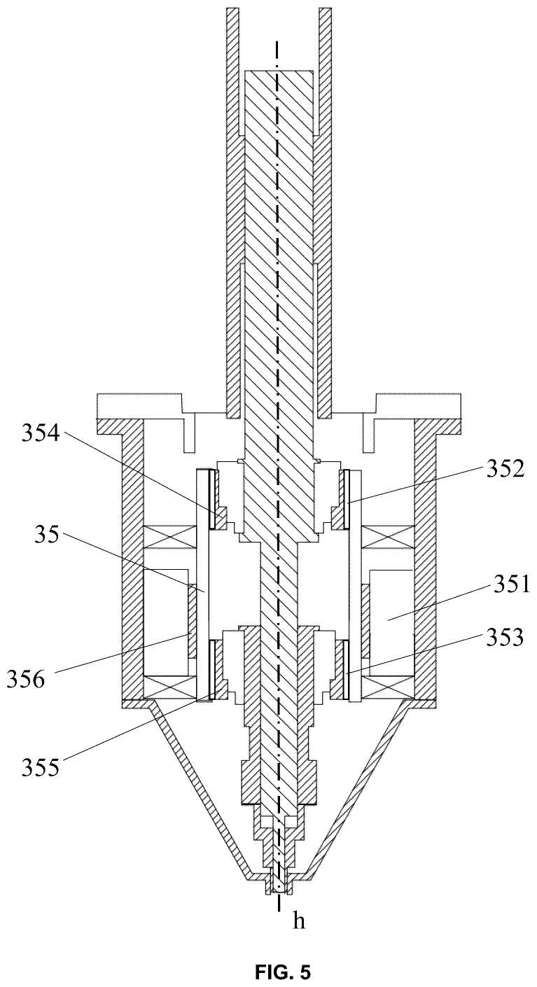

FIG. 5 is a schematic diagram illustrating another structure of a refill friction stir spot welding device according to some embodiments of the present disclosure.

In some embodiments, as shown in FIG. 5, the axial drive assembly may include only one hollow motor 351, and the lead screw may include a first lead screw 354 and a second lead screw 355.

In some embodiments, the lead screw nut 35 may be connected to a rotor 356 of the hollow motor 351. The lead screw nut 35 is provided with a first internal thread 352 and a second internal thread 353, thread rotation directions of the first internal thread 352 and the second internal thread 353 are opposite (for example, the first internal thread 352 is a right-hand thread, and the second internal thread 353 is a left-hand thread). The first internal thread 352 is in a driving connection with the first lead screw 354, and the second internal thread 353 is in a driving connection with the second lead screw 355. The driving connection is a thread-engaging driving connection, and the transmission mode may be found in the related descriptions above.

In some embodiments, the stir pin shaft 12 is rotatably connected to the first lead screw 354, and a relative motion between the stir pin shaft 12 and the first lead screw 354 along the axis h is locked. The stir sleeve shaft 22 is rotatably connected to the second lead screw 355, and a relative motion between the stir sleeve shaft 22 and the second lead screw 355 along the axis h is locked. The connection way and function way of the stir pin shaft 12 and the stir sleeve shaft 22 with the lead screw are similar to those described above and will not be repeated here. In some embodiments, a rotation of the lead screw nut 35 is capable of driving the stir pin 11 and the stir sleeve 21 in the direction of the axis h to make a same-speed movement along the direction of the axis h in opposite directions. For example, if the stir pin 11 moves upward along the axis h, then the stir sleeve 21 moves downward along the axis h; or, if the stir pin 11 moves downward along the axis h, then the stir sleeve 21 moves upward along the axis h.

In some embodiments, a thread pitch of the first internal thread 352 and a thread pitch of the second internal thread 353 may be set differently, and the different thread pitches may correspond to making the stir pin 11 and the stir sleeve 21 have different movement speeds. The thread pitch is positively correlated with the movement speed. That is, a ratio of the thread pitch of the first internal thread 352 to the thread pitch of the second internal thread 353 may be equal to a ratio of a movement speed of the stir pin 11 to a movement speed of the stir sleeve 21.

In some embodiments, the lead screw nut 35, the first lead screw 354, and the second lead screw 355 may be substituted according to a welding requirement, so as to realize the control for the movement speed of the stir pin 11 and the movement speed of the stir sleeve 21. For example, to achieve rapid filling of the keyhole during downward pressing, the movement speed of the stir pin 11 (which moves upward and downward along the axis h) may be set to be higher than that of the stir sleeve 21.

In some embodiments, using the only one hollow motor as the axial drive power source simplifies an overall structure and reduces an overall dimension of the refill friction stir spot welding device. At the same time, replacing the lead screw nut and the lead screw enables the control of the movement speeds of the stir pin 11 and the stir sleeve 21, thereby enhancing the applicability of the refill friction stir spot welding device.

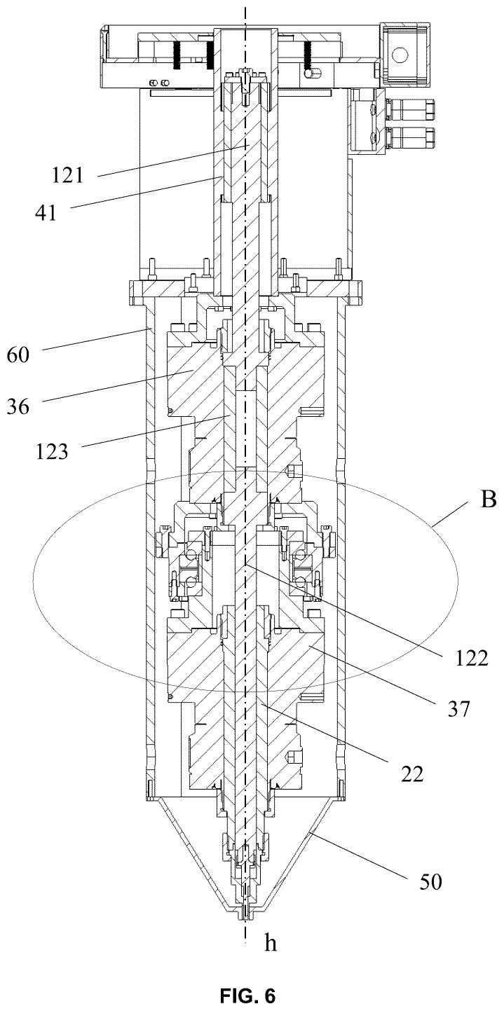

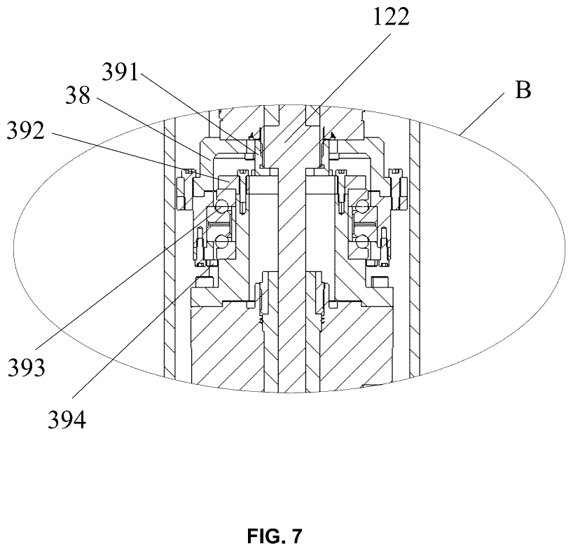

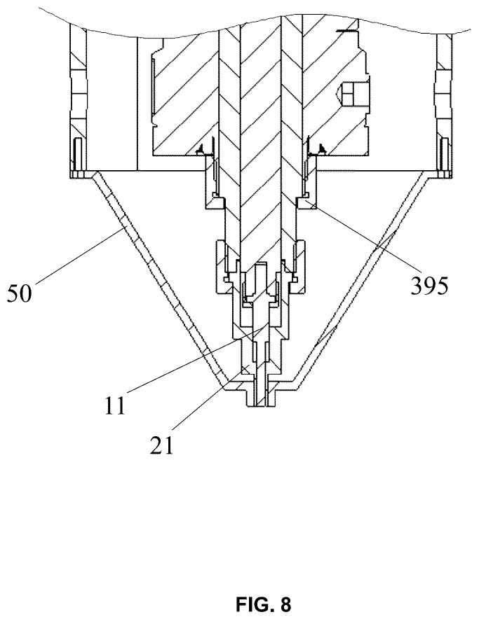

FIG. 6 is a schematic diagram illustrating another structure of a refill friction stir spot welding device according to some embodiments of the present disclosure. FIG. 7 is an enlarged schematic diagram of region B according to some embodiments of the present disclosure. FIG. 8 is a schematic diagram illustrating another structure of a portion of a refill friction stir spot welding device according to some embodiments of the present disclosure.

In some embodiments, the axial drive assembly may also include a first hollow power cylinder 36 and a second hollow power cylinder 37, as shown in FIG. 6.

A power cylinder is an actuating element that converts hydraulic or pneumatic energy into mechanical energy to do linear reciprocating motion. The power cylinder may utilize a difference in pressure of a liquid or a gas to produce a push force or a pull force on a piston rod, thus realizing the displacement of an object. The hollow power cylinder is a power cylinder with a hollow structure, and the hollow power cylinder may be a hollow hydraulic cylinder or pneumatic cylinder, etc. The first hollow power cylinder 36 is configured to drive the stir pin 11 to move along the axis h, and the second hollow power cylinder 37 is configured to drive the stir sleeve 21 to move along the axis h.

In some embodiments, the central axes of both the first hollow power cylinder 36 and the second hollow power cylinder 37 are located on the axis h. A piston rod of the first hollow power cylinder 36 is connected to the stir pin shaft 12, and a piston rod of the second hollow power cylinder 37 is connected to the stir sleeve shaft 22.

In some embodiments, the stir pin shaft 12 includes a first stir pin shaft 121 and a second stir pin shaft 122. Rotation axes of the first stir pin shaft 121 and the second stir pin shaft 122 are located on the axis h. The first stir pin shaft 121 and the second stir pin shaft 122 may be fixedly connected via a connecting rod 123, and the stir pin 11 is connected to the second stir pin shaft 122. In some embodiments, the connecting rod 123 may be disposed in a cavity within the first hollow power cylinder 36, and the connecting rod 123 may be in the shape of a hollow rod.

In some embodiments, by setting the first stir pin shaft 121 and the second stir pin shaft 122, an individual length of the stir pin shaft 12 is shortened without affecting the transmission effect, which makes the stir pin shaft 121 less susceptible to damage, and also allows for a compact structure, reduces the quality, and lowers the cost.

In some embodiments, the core shaft 41 may be sleeved outside the first stir pin shaft 121, the first stir pin shaft 121 and the core shaft 41 can perform a relative motion along the axis h, and the first stir pin shaft 121 and the core shaft 41 are in a rotation-locked engagement state. Merely by way of example, a spline may be disposed at a top of the first stir pin shaft 121, and a spline groove may be provided in an inner wall of the core shaft 41. More descriptions regarding the spline may be found in the related descriptions above.

In some embodiments, the connecting rod 123 is provided with a through-slot along the direction of the axis h, and both the first stir pin shaft 121 and the second stir pin shaft 122 are provided with pin heads that match the through-slot. The matching of the through-slot with the pin head can restrict the connecting rod 123 from moving relative to the first stir pin shaft 121 and the second stir pin shaft 122.

In some embodiments, the through-slot may be set in a preset shape, and the shape of the pin head is matched to the through-slot. The pin head is set at the lower end of the first stir pin shaft 121 and the upper end of the second stir pin shaft 122. The preset shape may be square, prismatic, or other shapes that are less prone to rotation.

In some embodiments, the second stir pin shaft 122 is provided with a third cooperating structure, and the stir pin 11 is provided with a fourth cooperating structure.

The third cooperating structure is a position-limiting structure provided on the second stir pin shaft 122. The fourth cooperating structure is a position limiting structure provided on the stir pin 11 that matches the third cooperating structure. The third cooperating structure and the fourth cooperating structure cooperate to restrict a relative motion between the second stir pin shaft 122 and the stir pin 11. The structures and ways of action of the third cooperating structure and the fourth cooperating structure are the same as those of the first cooperating structure and the second cooperating structure, which may be found in the related descriptions above.

In some embodiments, the stir sleeve shaft 22 is sleeved outside the second stir pin shaft 122, rotation axes of the stir sleeve shaft 22 and the second stir pin shaft 122 are located on the axis h, and the stir sleeve shaft 22 and the second stir pin shaft 122 can perform a relative motion along the axis h The stir sleeve shaft 22 and the second stir pin shaft 122 are in a rotation-locked engagement state; i.e., the stir sleeve shaft 22 and the second stir pin shaft 122 are unable to rotate relative to each other, and can only perform the rotational motion synchronously.

In some embodiments, the stir sleeve shaft 22 and the second stir pin shaft 122 may be connected in any feasible manner. Merely by way of example, the stir sleeve shaft 22 may be connected to an outer side of the second stir pin shaft 122 via a spline. More descriptions regarding the spline may be found in the related descriptions above.

In some embodiments, two ends of the piston rod of the first hollow power cylinder 36 are respectively connected to the first stir pin shaft 121 and the second stir pin shaft 122. Merely by way of example, as shown in FIG. 7, an upper end and a lower end of the piston rod of the first hollow power cylinder 36 may be secured to the first stir pin shaft 121 and the second stir pin shaft 122, respectively, by a first lock nut 391 in the direction of the axis h. When the first hollow power cylinder 36 is in operation, the piston rod of the first hollow power cylinder 36 is moved along the axis h, to drive the first stir pin shaft 121 and the second stir pin shaft 122 along the axis h.

In some embodiments, the stir sleeve shaft 22 is fixedly disposed inside the piston rod of the second hollow power cylinder 37. Merely by way of example, as shown in FIG. 8, the piston rod of the second hollow power cylinder 37 may be secured with the stir sleeve shaft 22 in the direction of the axis h by a second lock nut 395. When the second hollow power cylinder 37 is in operation, the piston rod of the second hollow power cylinder 37 is moved along the axis h, to drive the stir sleeve shaft 22 along the axis h.

In some embodiments, as shown in FIG. 7, a second spacer sleeve 38 is provided between the first hollow power cylinder 36 and the second hollow power cylinder 37, and the non-moving part of the two hollow power cylinders can be fixedly connected through the second spacer sleeve 38. The moving parts of the two hollow power cylinders can be separated from the non-moving parts by a bearing 393, and the top and bottom of the bearing 393 are limited and fixed by an upper bearing cover 392 and a lower bearing cover 394, respectively.

In some embodiments, two hollow power cylinders configured coaxially are configured to control the movement of the stir pin 11 and the stir sleeve 21. This design solves the problem of bending moments generated by a side-shaft drive and ensures system rigidity during the welding process, and the structure remains compact and reliable, which can eliminate the need for a deceleration device. In addition, the mechanism operates without transmission gaps and achieves smooth movement. Furthermore, this configuration overcomes the problems of motor lead screws and other drive components being embedded inside the spindle, which can cause a lack of compactness and difficulties in coaxial control. The design has a wide range of applications and can be applied to dynamic-shoulder and static-shoulder stir friction welding devices, gantry-style devices, robotic-arm-style devices, and other friction stir spot welding devices.

In some embodiments, the refill friction stir spot welding device may further include a hollow motor and a hollow power cylinder as previously described. The hollow motor is configured to drive any one of the stir pin 11 and the stir sleeve 21, and the hollow power cylinder is configured to drive the other one of the stir pin 11 and the stir sleeve 21. It is to be understood that the structure of the hollow motor, the structure of the hollow power cylinder, the structure of the stir pin assembly, and the structure of the stir sleeve assembly are the same as those described above, and the connection manner can be described with reference to the descriptions above without further elaboration.

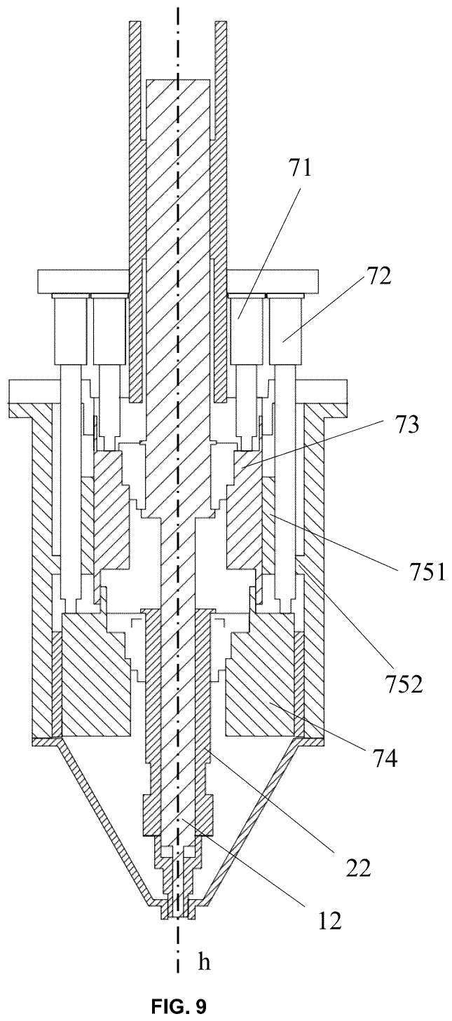

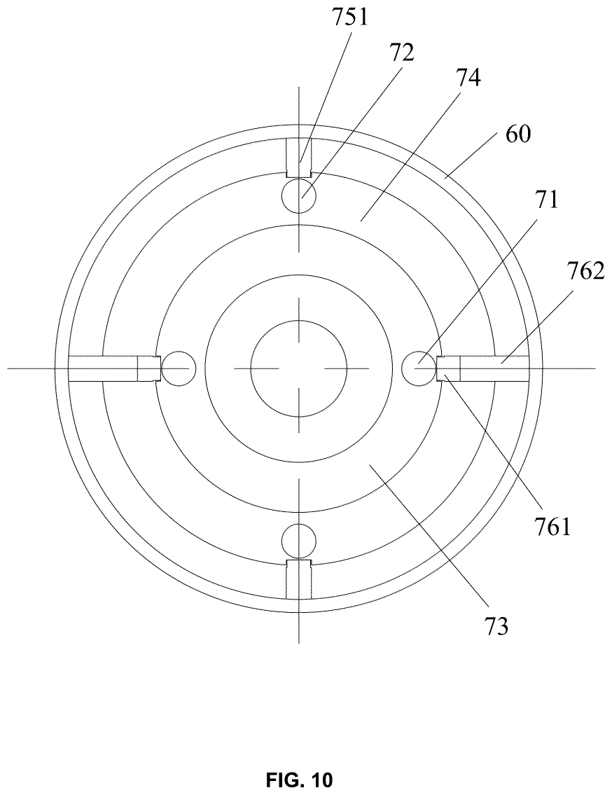

FIG. 9 is a schematic diagram illustrating another structure of a refill friction stir spot welding device according to some embodiments of the present disclosure. FIG. 10 is a schematic diagram illustrating a section of a refill friction stir spot welding device according to some embodiments of the present disclosure.

In some embodiments, the axial drive assembly includes an inner power cylinder 71 and an outer power cylinder 72, as shown in FIG. 9 and FIG. 10.

In some embodiments, a piston rod of the inner power cylinder 71 is connected to a first hollow slider 73, the first hollow slider 73 is sleeved outside the stir pin shaft 12, and a center axis of the first hollow slider 73 is located on the axis h. The stir pin shaft 12 and the first hollow slider 73 can perform a rotational relative motion, and a relative motion between the stir pin shaft 12 and the first hollow slider 73 along the axis h is locked.

In some embodiments, the first hollow slider 73 and the stir pin shaft 12 may be connected by a bearing via a first push force, the first hollow slider 73 may be slidably connected to a first guiding rail 751, and the first guiding rail 751 may be fixedly connected to the outer casing 60 via a first fixing member 752. The piston rod of the inner power cylinder 71 extends and retracts, which can push the first hollow slider 73 to move along the axis h and drive the stir pin shaft 12 to move along the axis h.

In some embodiments, a piston rod of the outer power cylinder 72 is connected to a second hollow slider 74, the second hollow slider 74 is sleeved outside the stir sleeve shaft 22, and a center axis of the second hollow slider 74 is located on the axis h. The stir sleeve shaft 22 and the second hollow slider 74 can perform a rotational relative motion, and a relative motion between the stir sleeve shaft 22 and the second hollow slider 74 along the axis h is locked.

In some embodiments, the second hollow slider 74 and the stir sleeve shaft 22 may be connected by a bearing via a second push force, the second hollow slider 74 may be slidably connected to a second guiding rail 761, and the second guiding rail 761 may be fixedly connected to the outer casing 60 via a second fixing member 762. The piston rod of the outer power cylinder 72 extends and retracts, which can push the second hollow slider 74 to move along the axis h and drive the stir sleeve shaft 22 to move along the axis h.

In some embodiments, a count of the inner power cylinders 71 is at least two, and the at least two of the inner power cylinders 71 are distributed around the axis h as the center. A count of the outer power cylinders 72 is at least two, and the at least two of the outer power cylinders are distributed around the axis h as the center.

In some embodiments, the at least two of the inner power cylinders 71 may be provided with synchronous circuits. For example, an electrohydraulic servo valve may be used to achieve the circuit for the synchronous motion. A servo valve in the circuit continuously controls the opening of its valve port based on feedback signals from two displacement sensors, so that a flow rate passing through the servo valve is the same as a flow rate passing through a directional valve, thereby ensuring that the two inner power cylinders achieve bidirectional synchronous motion. As another example, the synchronous circuit can be achieved by connecting hydraulic cylinders in series. The oil discharged from a return chamber of a first hydraulic cylinder is fed into the inlet chamber of a second hydraulic cylinder. If the effective areas of the pistons in the oil chambers connected in series are equal, the synchronous motion can be achieved. This type of circuit allows two cylinders to withstand different loads, but an oil supply pressure of a pump should be greater than the sum of working pressures of the two cylinders. It can be understood that the at least two of the outer power cylinders 72 have synchronous circuits in the same way as the inner power cylinders 71, which will not be repeated.

In some embodiments, at least two of the inner power cylinders 71, as well as at least two of the outer power cylinders 72 (e.g., a total of four power cylinders) can be accomplished by a set of hydraulic circuits. For example, a relay can be utilized to select the inner power cylinder 71 or the outer power cylinder 72 to perform an action, and a diverter valve can be utilized to control the movement speed of the power cylinder.

In some embodiments, the refill friction stir spot welding device may include a pressing sleeve 50.

The pressing sleeve 50 is a component for pressing a workpiece to be welded. The pressing sleeve 50 may have a circular or columnar structure, and the pressing sleeve 50 may be made of a plurality of materials, such as high-strength steel. When welding is performed, the pressing sleeve 50 is positioned and pressed against the workpiece to be welded, thereby positioning and fixing the refill friction stir spot welding device.

In some embodiments, both the stir sleeve 21 and the stir pin 11 are capable of both moving and being controlled independently relative to the pressing sleeve 50. Merely by way of example, a robotic arm controls the pressing sleeve 50 to compress the workpiece to be welded, the rotary drive assembly controls the rotation of the stir sleeve 21 and the stir pin 11 with respect to the pressing sleeve 50, and the axial drive assembly controls the axial movement of the stir sleeve 21 and the stir pin 11 with respect to the pressing sleeve 50.

In some embodiments, a lower portion of the pressing sleeve 50 is provided with an opening, and at least a portion of the stir sleeve 21 is movably disposed in the opening along the axis h. In some embodiments, a surface roughness of a contact surface between the stir sleeve 21 and the pressing sleeve 50 is less than 0.08 μm, i.e., the contact surface between the stir sleeve 21 and the pressing sleeve 50 is set to be a mirror surface, so as to reduce the friction generated during the relative motion between the stir sleeve 21 and the pressing sleeve 50 along the direction of the axis h, thereby reducing a wear and tear of the device.

In some embodiments, a surface roughness of a contact surface between the stir sleeve 21 and the stir pin 11 is less than 0.08 μm, i.e., the contact surface between the stir sleeve 21 and the stir pin 11 is set to be a mirror surface, so as to reduce the friction generated during the relative motion between the stir sleeve 21 and the stir pin 11 along the direction of the axis h, thereby reducing a wear and tear of the device. The surface roughness of less than 0.08 μm is only a preferred embodiment, and the surface roughness may be adjusted according to different working conditions in the actual working process.

In some embodiments, the outer casing 60 may be composed of a combination of multiple casing structures for ease of disassembly and maintenance. In some embodiments, locations on the outer casing 60 for mounting bearings may be correspondingly provided as a step structure to facilitate mounting of the bearings.

In some embodiments, as shown in FIG. 4, the refill friction stir spot welding device (hereinafter referred to as the device) further includes a processor 410, a force sensor 420, a torque sensor 430 (as shown in FIG. 2), an infrared thermal camera 440, and an image acquisition device 450. The force sensor 420 is configured to acquire force data; the torque sensor 430 is configured to acquire torque data; the infrared thermal camera 440 is configured to acquire thermal imaging data; and the image acquisition device 450 is configured to acquire a weld image. The processor 410 is configured to: determine a first welding parameter based on a material property and dimensional information of the workpiece to be welded; control the axial drive assembly and the rotary drive assembly to weld the workpiece to be welded based on the first welding parameter; determine a welding quality during a welding process based on the force data, the torque data, the thermal imaging data, and the weld image; and determine a second welding parameter based on the welding quality, and control the axial drive assembly and the rotary drive assembly to weld the workpiece to be welded based on the second welding parameter.

In some embodiments, the processor 410 is one of a distal processor or a proximal processor. The processor 410 includes a programmable logic processing unit (PLC), a digital signal processor (DSP), a central processing unit (CPU), or the like, or any combination thereof. The processor 410 is communicatively connected to one or more of the force sensor 420, the torque sensor 430, the infrared thermal camera 440, and the image acquisition device 450 to enable information and/or data transfer and exchange between the various components. For example, the force sensor 420 and the torque sensor 430 may send the force data and the torque data to the processor. As another example, the processor may send the first welding parameter to the axial drive assembly or the rotary drive assembly. The communication connection manner includes a network connection, such as a local area network CAN, Bluetooth, or the like. The processor may be set in any feasible location. For example, the processor is provided on the axial drive assembly or the rotary drive assembly. As another example, the processor is provided on a computer of a technician.

The force sensor 420 is configured to collect force data of components in the device in real time or at regular intervals. The force data refers to data related to a force applied to a component in the device. For example, the force sensor 420 includes a strain force sensor and a piezoelectric force sensor, or the like. In some embodiments, the stir sleeve 21, the stir pin 11, and the pressing sleeve 50 are provided with force sensors in close proximity to the workpiece to be welded to obtain a stir sleeve force, a stir pin force, and a pressing sleeve force.

The torque sensor 430 is configured to collect torque data from components in the device in real time or at regular intervals. The torque data refers to data relating to a torque applied to a component in the device. For example, the torque sensor 430 includes a strain gauge sensor, a phase difference sensor, or the like. In some embodiments, the torque sensor 430 is disposed at an output end of the axial drive assembly (e.g., at a connection between the axial drive assembly and the stir pin shaft 12), and at an output end of the rotary drive assembly (e.g., at a connection between the rotary drive assembly and the stir sleeve shaft 22) to obtain an axial torque of the axial drive assembly and a rotary torque of the rotary drive assembly.

The infrared thermal camera 440 is configured to acquire thermal imaging data in real time or at regular intervals during a welding process. The infrared thermal camera 440 includes a multi-spectral thermal imager and a short-wave thermal imager. The thermal imaging data refers to data related to a heat distribution of a weld seam and the surrounding workpieces during the welding process. In some embodiments, the infrared thermal camera 440 is provided on a component of the device that is not involved in rotation, as shown in FIG. 4. For example, the infrared thermal camera 440 is provided on an outside of the pressing sleeve 50.

The image acquisition device 450 is configured to acquire a weld image during the welding process in real time or at regular intervals. The weld image refers to an optical image during the welding process. The image acquisition device 450 includes a camera, an industrial camera, etc. In some embodiments, the image acquisition device 450 is provided in a location similar to that of the infrared thermal camera 440.

The material property refers to a characteristic related to the material of the workpiece to be welded. For example, the material property includes the material of the workpiece to be welded, a cladding material, a thickness of the cladding material, or the like. In some embodiments, the processor 410 obtains the material property entered by a user or selected by the user.

The dimensional information refers to information related to a dimension of the workpiece to be welded. For example, the dimensional information includes a thickness of the workpiece to be welded, a weld width requirement, whether there is a pre-fabricated hole, whether the workpiece to be welded is of a special geometry, or the like. In some embodiments, the processor 410 obtains the dimensional information entered by the user or selected by the user.

The first welding parameter refers to an initially determined welding parameter. In some embodiments, the first welding parameter includes at least a relative axial position, a relative axial speed, a time sequence, and a dwell time. The first welding parameter also includes a rotational speed, an absolute axial position, and an absolute axial speed, or the like.

The relative axial position refers to an axial projection of the stir pin 11 relative to the stir sleeve 21. The absolute axial position refers to a position of the stir pin 11 or the stir sleeve 21 with respect to the pressing sleeve 50 in the direction of the axis h.

The relative axial speed refers to a speed of the axial movement of the stir pin 11 relative to the stir sleeve 12. The absolute axial speed refers to a speed at which the stir pin 11 or the stir sleeve 21 moves in the direction of the axial h with respect to the pressing sleeve 50.

The time sequence refers to a sequential order of the movements in each stage of welding. For example, after the stir pin 11 moves along the axis for 1 second, the stir sleeve 12 moves. The dwell time refers to a duration during which the absolute axial position of the stir pin 11 or the stir sleeve 12 remains unchanged, and only rotational movement is performed.

In some embodiments, the processor 410 constructs a first feature vector based on the material property and the dimensional information of the workpiece to be welded, and determines, via a first vector database, a reference first welding parameter corresponding to a first reference vector with a vector similarity greater than a similarity threshold as the first welding parameter. The similarity threshold is set based on experience. The first vector database includes Milvus, Faiss, etc. The first vector database includes a plurality of first reference vectors and their corresponding reference first welding parameters. The first vector database is constructed by a skilled person based on experiments. For example, the processor constructs a first reference vector based on the material property and the dimensional information of the workpiece to be welded. Under the condition that the first reference vectors are provided, a technician conducts welding experiments employing a plurality of sets of welding parameters and selects a welding parameter meeting a preset requirement as the reference first welding parameter. By means of the above manner, a plurality of sets of first reference vectors along with the corresponding reference first welding parameters are obtained. The preset requirement includes that no damage occurs to the weld joints, or a count of damages to weld joints is less than a quantity threshold during a subsequent preset time period. The preset time period and the quantity threshold are set based on experience.

In some embodiments, the processor 410 controls the axial drive assembly and the rotary drive assembly to drive the stir pin 11 and the stir sleeve 21 to perform an axial motion or rotation based on the first welding parameter, thereby realizing welding of the workpiece to be welded.

The welding quality refers to a degree to which a product meets a technical requirement after welding. For example, the welding quality includes a type of welding defects (e.g., unfused, presence of porosity, etc.), a welding defect probability, or the like.

In some embodiments, the processor 410 determines the welding quality based on a quality model.

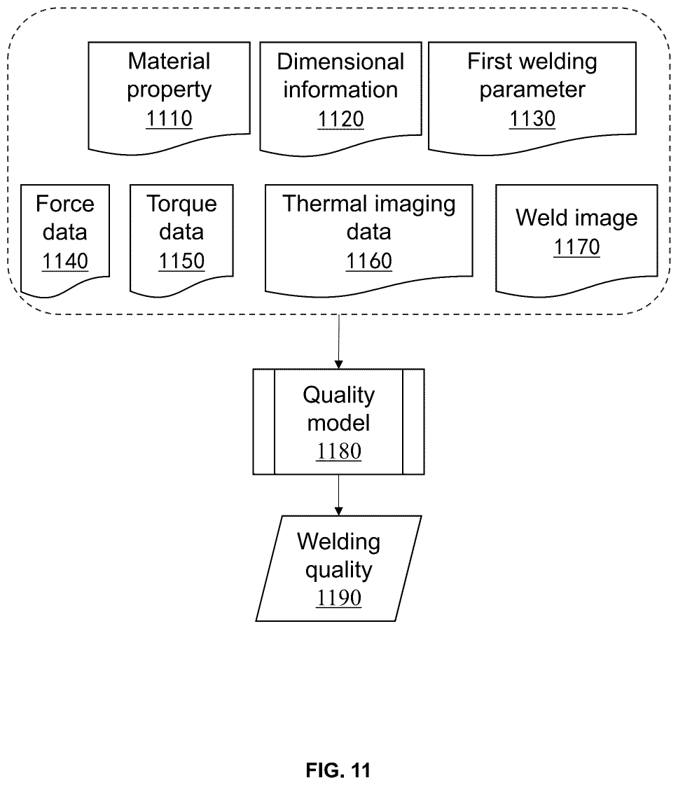

FIG. 11 is a flowchart of an exemplary process for determining a welding quality based on a quality model according to some embodiments of the present disclosure.

In some embodiments, as shown in FIG. 11, an input of the quality model 1180 includes a material property 1110, dimensional information 1120, a first welding parameter 1130, force data 1140, torque data 1150, thermal imaging data 1160, and a weld image 1170, and an output of the quality model 1180 includes a welding quality 1190.

In some embodiments, the quality model is a machine learning model, for example, a convolutional neural network (CNN) model, any other customized model, or the like, or a combination thereof.

In some embodiments, the quality model is obtained by training with a training sample set, and the training sample set includes a plurality of first training samples with first labels. For example, the plurality of first training samples with the first labels are input into an initial quality model, a loss function is constructed from the first labels and the results of the initial quality model, and the loss function is iteratively updated based on the loss function by gradient descent or other methods to update the parameters of the initial quality model. The model training is completed when a preset condition is satisfied, and the trained quality model is obtained. The preset condition is the loss function convergence, a count of iterations reaches a threshold, etc.

The first training sample includes a sample material property of the workpiece to be welded, sample dimensional information, sample force data, sample torque data, sample thermal imaging data, and a sample weld image. The first training sample may be historical data. The first label is obtained by manual labeling based on the real detection result of the first training sample. For example, if a hole defect occurs in the welding process of the first training sample, the type of the welding defect in the welding quality is “hole defect”, and the welding defect probability is “1”; if a hole defect does not occur, the type of the welding defect in the welding quality is “none”, and the welding defect probability is “0”.

In some embodiments, the processor alternately trains the quality model based on at least two training sample sets. The training sample set may be divided based on the sample material property of the workpiece to be welded, such that training samples with the same or similar sample material property are divided into the same training sample set. The learning rate of training is different for different training sample sets, and the learning rate of the training sample set is negatively correlated with a backfill phase percentage of the training sample set.

In some embodiments, the processor determines an axial force-rotational speed coupling relationship based on an axial force-rotational speed phase division method, and determines a backfill phase percentage of the first training sample based on the axial force-rotational speed coupling relationship.

The axial force-rotational speed coupling relationship refers to a dynamic coupling relationship between an axial force and a rotational speed.

In some embodiments, the axial force-rotational speed phase division method is performed by the processor and includes the following steps S1-S2.

S1, force data and rotational speeds at multiple time points of the training sample set are obtained, and a phase angle of a welding parameter for each of the multiple time points is determined. In some embodiments, the force data includes one of a stir sleeve force and a stir pin force. The processor 410 obtains the stir sleeve force and the stir pin force at the multiple time points via the force sensor 420, and reads the rotational speeds at the multiple time points from the first welding parameter.

The phase angle of the welding parameter at the time point may be determined by mapping the force data and the rotational speed into a polar coordinate system. Merely by way of example, the phase angle of the welding parameter at the time point is determined by the following steps. A difference is determined by subtracting the real-time force at the time point from the product of a material friction coefficient and an average force in the training sample set. The difference is divided by the product of the rotational speed at the time point and the radius at the time point. Finally, the phase angle is obtained using a trigonometric function. The real-time force refers to the stir sleeve force or the stir pin force corresponding to the time point. Accordingly, the average force refers to an average stir sleeve force or an average stir pin force at the multiple time points of the training sample set. The radius refers to a stir sleeve radius or a stir pin radius. The material friction coefficient refers to a coefficient of friction of the workpiece to be welded. The material friction coefficient and the radius are preset by the technician. The processor may also normalize the force data and the rotational speed before determining the phase angle to facilitate data computation.

S2, the backfill phase percentage for the multiple time points in the training sample set is determined based on a phase angle threshold. The phase angle threshold indicates a threshold from the material mixing phase to a backfill phase. The material mixing phase refers to a phase in which materials of the welded joint become fused. The backfill phase refers to a phase in which the stir pin or the stir sleeve is withdrawn to fill the keyhole. The phase angle threshold may be preset by a technician based on the material property and the dimensional information of the workpiece to be welded.

For example, the processor takes a ratio of the count of time points, where the phase angle of the training sample is greater than the phase angle threshold, to the total number of time points in the training sample set as the backfill phase percentage. Merely by way of example, if the phase angle threshold is 120°, and the training sample set contains data for 100 time points, of which 40 time points have a phase angle greater than 120°, the backfill phase percentage for the training sample set is 40%.

In some embodiments of the present disclosure, the material mixing phase produces the welded joint with a reliable connection. The changes in welding parameters during the material mixing phase are relatively stable. Therefore, setting a higher learning rate can save the training time of the model. In the backfill phase, the material flow is complex and welding defects are prone to occur, so a smaller learning rate is set to ensure that the model can detect anomalies or predict potential defects.

The second welding parameter refers to a welding parameter obtained by adjusting the first welding parameter based on the welding quality.

In some embodiments, the processor determines the second welding parameter in a plurality of ways.

For example, the processor determines the second welding parameter based on the welding quality via a first preset table. The first preset table is constructed based on experience. The first preset table includes the type of welding defects and the corresponding adjustment magnitude (e.g., the magnitude of adjusted axial speed, the magnitude of adjusted rotational speed, etc.), and the processor determines the second welding parameter based on the adjustment magnitude.

In some embodiments, the processor is further configured to: determine a material flow trend based on the first welding parameter, the thermal imaging data, and the weld image; and determine the second welding parameter based on the material flow trend and the welding quality.

The material flow trend refers to a trend of material flow. In some embodiments, the material flow trend includes at least one of insufficient material flow, material transition flow, and uneven material flow.

In some embodiments, the processor determines, via a fluid dynamics model, the material flow trend based on the first welding parameter, the thermal imaging data, and the weld image. The fluid dynamic model includes a computational fluid dynamics (CFD) model or a smoothed particle hydrodynamics (SPH) model.

In some embodiments, the processor constructs a second feature vector based on the material flow trend and the welding quality, and determines the second welding parameter via a second vector database.

The second vector database includes a plurality of second reference vectors and the corresponding reference second welding parameters. The second reference vector includes a reference material flow trend and a reference welding quality.

The manner for determining the second welding parameter via the second vector database is similar to the manner for determining the first welding parameter via the first vector database, and the manner of constructing the second vector database is the same as the manner of constructing the first vector database, further details regarding construction are not repeated here.

In some embodiments of the present disclosure, the material flow trend is determined in real time based on a plurality of data points and images during the welding process. The welding parameter is adjusted based on the determined material flow trend and the welding quality. The material flow abnormalities and welding defects caused by inappropriate first welding parameters are timely reduced. Therefore, the welding process stability and finished product quality are improved.

In some embodiments, the processor controls the axial drive assembly and the rotary drive assembly to drive the stir pin 11 and the stir sleeve 21 to move axially or rotate based on the second welding parameter, thereby welding the workpiece to be welded.

In some embodiments of the present disclosure, by determining the initial welding parameter based on the attributes and dimensions of the workpiece to be welded, the cost of manual trial and error can be reduced. By assessing, based on the plurality of pieces of data collected in the course of the welding process, the welding quality in a timely manner so as to facilitate subsequent dynamic adjustment of the welding parameter, welding defects can be reduced.

In some embodiments, the second welding parameter includes a vibration parameter. The vibration parameter corresponds to an active vibration mode of the refill friction stir spot welding device. The vibration parameter includes a rotational pulse, a stir pin axial pulse, and a stir sleeve axial pulse.

The active vibration mode is a mode in which a small vibration is actively superimposed on the basis of a rotational or axial motion of the device, so as to improve the welding quality at a microscopic level.

In some embodiments, each of the rotational pulse, the stir pin axial pulse, and the stir sleeve axial pulse may include a frequency, an amplitude, a waveform, and a duty cycle. The rotational pulse corresponds to a rotational motion, the stir pin axial pulse corresponds to a stir pin axial motion, and the stir sleeve axial pulse corresponds to a stir sleeve axial motion. Merely by way of example, the stir pin axial pulse is a high-frequency pulse that causes the stir pin to vibrate up and down in the direction of the axis with a small amplitude (e.g., up and down with a movement of 0.1 mm).

In some embodiments, the reference second welding parameter of the second vector database further includes a reference vibration parameter. The processor determines the vibration parameter via the second vector database.

In some embodiments, the processor may determine the vibration parameter in the second welding parameter based on the material flow trend and the welding quality via a vibration model.

The vibration model refers to a model configured to determine the vibration parameter. In some embodiments, the vibration model may be a machine learning model, for example, a deep neural network (DNN) model, or the like.

In some embodiments, an input of the vibration model includes the material flow trend and the welding quality, and an output of the vibration model includes the vibration parameter in the second welding parameter. The output of the vibration model also includes other second welding parameters besides the vibration parameter. More descriptions regarding the material flow trend and the welding quality may be found in the related descriptions above.

In some embodiments, the vibration model may be trained based on a plurality of second training samples having second labels. The training process of the vibration model is similar to that of the quality model and is not described herein.

In some embodiments, the second training sample includes a sample material flow trend and a sample welding quality. In some embodiments, the second training samples are a plurality of superior experimental data obtained by screening the experimental data. The superior experimental data is experimental data when the welding quality is better. For example, the technician controls the device to perform welding tests in the active vibration mode, and identifies the experimental data where a quality of a final welded product is better (e.g., where the final welded product is excellent) as the superior experimental data. The second labels are actual vibration parameters corresponding to the superior experimental data. When the output of the vibration model also includes the second welding parameter besides the vibration parameter. The second label is the actual second welding parameter corresponding to the superior experimental data.

In some embodiments of the present disclosure, in addition to axial and rotational motions, the device is capable of applying controllable high-frequency micro vibrations to one or more of the stir pin, the stir sleeve, or the pressing sleeve through the active vibration mode. The high-frequency micro vibration can promote the mixing of welding materials, breaking of oxide films, elimination of gases, grain refinement, improvement of interfacial wettability, or the like, at the micro scale on the basis of macroscopic material flow, thereby improving the welding quality. At the same time, the vibration parameter of the active vibration mode is dynamically adjusted based on real time feedback, which can be accurately adjusted based on the current welding quality.

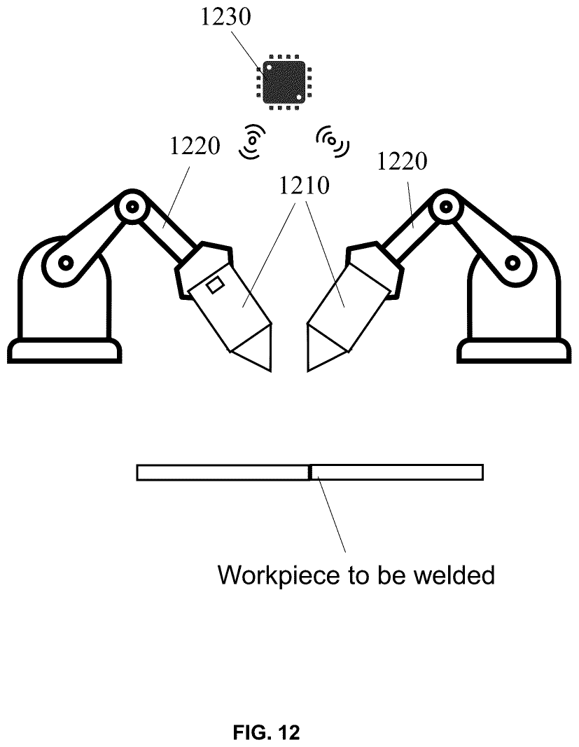

FIG. 12 is a schematic diagram illustrating a structure of a welding system according to some embodiments of the present disclosure.

Some embodiments of the present disclosure also provide a welding system. As shown in FIG. 12, the welding system includes two refill friction stir spot welding devices 1210, two robotic arms 1220, and a processing unit 1230. The two refill friction stir spot welding devices 1210 are respectively mounted on the two robotic arms 1220. The processing unit 1230 is configured to process data/information related to an operation of the welding system. As shown in FIG. 12, the processing unit 1230 may be independently set up and communicatively connected to the processor 410 of each of the two refill friction stir spot welding devices 1210. The processing unit 1230 may also be the processor 410 of at least one of the two refill friction stir spot welding devices 1210. The processing unit 1230 may have similar functionality and structure to the processor 410, see the preceding description of the processor 410.

In some embodiments, each of the two refill friction stir spot welding devices 1210 includes: a stir pin assembly, the stir pin assembly including a stir pin; a stir sleeve assembly, the stir sleeve assembly including a stir sleeve, the stir sleeve being sleeved outside of the stir pin, the stir sleeve and the stir pin having the same axis; and, an axial drive assembly and a rotary drive assembly. The axial drive assembly drives the stir pin and the stir sleeve to move along the axis, respectively. The rotary drive assembly drives the stir pin and the stir sleeve to perform a rotational motion centered on the axis, and both the center axis of the axial drive assembly and the rotary axis of the rotary drive assembly are located on the axis. More descriptions regarding the refill friction stir spot welding device may be found in the related descriptions above.

In some embodiments, the two refill friction stir spot welding devices have different rotary drive assemblies, and/or the two refill friction stir spot welding devices have different axial drive assemblies.

In some embodiments, the processing unit 1230 is further configured to: determine a target robotic arm based on a historical welding quality, a material property of the workpiece to be welded, and dimensional information, and control the target robotic arm to perform the welding of the workpiece to be welded.

The robotic arm 1220 refers to a component that drives the refill friction stir spot welding device 1210 to move. The robotic arm 1220 may be of various types. For example, the robotic arm 1220 may be a four-axis robotic arm, a six-axis robotic arm, or the like.

In some embodiments, the refill friction stir spot welding device 1210 is removably connected to the robotic arm 1220. For example, the refill friction stir spot welding device 1210 may be removably connected to the robotic arm 1220 through the cooperation of flanges and bolts. The robotic arm 1220 is a universal machine in existing technology, so it will not be further described.

In some embodiments, the difference between the rotary drive assemblies of the two refill friction stir spot welding devices refers to a difference in the type of rotary drive assemblies. For example, the rotary drive assembly of one of the devices is an electric spindle, and the rotary drive assembly of the other device is a mechanical spindle.

In some embodiments, the difference between the axial drive assemblies of the two refill friction stir spot welding devices refers to a difference in the type of axial drive assemblies. For example, one of the devices includes an axial drive assembly consisting of a first hollow motor and a second hollow motor, while the other device includes a rotary drive assembly consisting of a first hollow power cylinder and a second hollow power cylinder. As another example, one of the devices includes an axial drive assembly composed of only one hollow motor, and the other device includes a rotary drive assembly composed of a first hollow motor and a second hollow motor. More descriptions regarding the rotary drive assembly and the axial drive assembly may be found in the related descriptions above.

The historical welding quality refers to a welding quality in the historical data. More descriptions regarding the welding quality may be found in the related descriptions above.

The target robotic arm refers to the corresponding robotic arm of the refill friction stir spot welding device, ultimately used for welding. The target robotic arm has two robotic arms or one of a plurality of robotic arms.

In some embodiments, the processing unit may determine the target robotic arm in a plurality of ways. For example, the processing unit determines, via a second preset table, the target robotic arm based on the material property and the dimensional information of the workpiece to be welded and the historical welding quality. The second preset table includes a correspondence among the material property and the dimensional information of the workpiece to be welded, the historical welding quality, and the target robotic arm. The second preset table may be constructed based on the aforementioned superior experimental data. For example, the technician may identify the robotic arm of the superior experimental data as the target robotic arm corresponding to the material property and the dimensional information of the workpiece to be welded in the second preset table. The superior experimental data also takes into account the welding quality for the active vibration mode, and the second preset table established in this way results in a target robotic arm with better welding quality.

Different drive types have their own advantages. For example, a motor has an advantage in the pursuit of fast dynamic response; however, in terms of heat dissipation, the heating of the motor may affect its life. As another example, a hydraulic power cylinder has an advantage in thrust retention and is suitable for a large tonnage downward pressure requirement (e.g., for a large size of the workpiece to be welded). For the workpieces to be welded with different material properties and different dimensional information, the welding qualities obtained by the different drive types may be different. In some embodiments of the present disclosure, selecting, based on the material property and the dimensional information of the workpiece to be welded, a more suitable target robotic arm is selected to improve the welding quality.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A refill friction stir spot welding device, comprising:
a stir pin assembly including a stir pin;
a stir sleeve assembly including a stir sleeve, the stir sleeve being sleeved outside the stir pin, the stir sleeve having a same axis as the stir pin; and
an axial drive assembly and a rotary drive assembly, the axial drive assembly driving the stir pin and the stir sleeve, respectively, to move along the axis, the rotary drive assembly driving the stir pin and the stir sleeve to perform a rotational motion centered on the axis, a center axis of the axial drive assembly and a rotary axis of the rotary drive assembly are both located on the axis.

2. The refill friction stir spot welding device according to claim 1, wherein the stir pin assembly includes a stir pin shaft, the stir pin shaft being fixedly connected to the stir pin, a rotational axis of the stir pin shaft and a rotational axis of the stir pin being located on the axis.

3. The refill friction stir spot welding device according to claim 2, wherein the stir pin shaft is provided with a first cooperating structure, the stir pin is provided with a second cooperating structure, and the first cooperating structure cooperates with the second cooperating structure to restrict a relative motion between the stir pin shaft and the stir pin.

4. The refill friction stir spot welding device according to claim 3, wherein the first cooperating structure includes a cylindrical groove formed at a bottom of the stir pin shaft, the second cooperating structure includes a rectangular structure disposed at a top end of the stir pin, and the rectangular structure is capable of being embedded into the cylindrical groove; or
the first cooperating structure includes a cruciform hole formed at the bottom of the stir pin shaft, the second cooperating structure includes a cruciform structure disposed at the top end of the stir pin, and the cruciform structure is capable of being embedded into the cruciform hole; or
the first cooperating structure includes a tapered hole disposed at the bottom of the stir pin shaft, the second cooperating structure includes a tapered structure disposed at the top end of the stir pin, and the stir pin shaft and the stir pin are fixedly assembled by interference fit via the tapered hole and the tapered structure.

5. The refill friction stir spot welding device according to claim 2, wherein the stir sleeve assembly includes a stir sleeve shaft, the stir sleeve shaft being sleeved outside the stir pin shaft, a rotational axis of the stir sleeve shaft and a rotational axis of the stir pin shaft being on the axis, the stir sleeve shaft and the stir pin shaft being capable of undergoing a relative motion along the axis, the stir sleeve shaft and the stir pin shaft being in a rotation-locked engagement state, the stir sleeve shaft being fixedly connected to the stir sleeve.

6. The refill friction stir spot welding device according to claim 5, wherein the axial drive assembly includes at least one hollow motor, a central shaft of the at least one hollow motor is located on the axis, and the at least one hollow motor drives at least one of the stir pin shaft or the stir sleeve shaft along the axis via a lead screw transmission assembly.

7. The refill friction stir spot welding device according to claim 6, wherein the at least one hollow motor includes a first hollow motor and a second hollow motor, the first hollow motor driving the stir pin shaft along the axis through a first set of the lead screw transmission assembly, the second hollow motor driving the stir sleeve shaft along the axis through a second set of the lead screw transmission assembly.

8. The refill friction stir spot welding device according to claim 7, wherein first rolling bearings are disposed on both upper and lower sides of the first hollow motor, first spacer sleeves are fixedly abutted against both sides of the first rolling bearings, outer rings of the first rolling bearings limit a stator of the first hollow motor along a direction of the axis, a rotor of the first hollow motor is fixedly connected to a lead screw nut of the first set of the lead screw transmission assembly, inner rings of the first rolling bearings limit the lead screw nut along the direction of the axis, a lead screw of the first set of the lead screw transmission assembly is sleeved on an outer side of the stir pin shaft, and the lead screw of the first set of the lead screw transmission assembly and the stir pin shaft are connected via a second rolling bearing, a first bearing cover and a first bearing lock nut are respectively disposed above and below the second rolling bearing; and
a rotor of the second hollow motor is connected to a lead screw of the second set of the lead screw transmission assembly via a lead screw nut of the second set of the lead screw transmission assembly, third rolling bearings are disposed on both upper and lower sides of the second hollow motor, outer rings of the third rolling bearings limit a stator of the second hollow motor along the direction of the axis, inner rings of the third rolling bearings limit the lead screw nut along the direction of the axis, the lead screw of the second set of the lead screw transmission assembly is sleeved on an outer side of the stir sleeve shaft, and the lead screw of the second set of the lead screw transmission assembly and the stir sleeve shaft are connected via a fourth rolling bearing, a second bearing cover and a second bearing lock nut are respectively disposed above and below the fourth rolling bearing.

9. The refill friction stir spot welding device according to claim 6, wherein the lead screw transmission assembly includes a lead screw and a lead screw nut, the lead screw and the lead screw nut are in a driving connection, the lead screw nut is connected to a rotor of the at least one hollow motor, at least one of the stir pin shaft or the stir sleeve shaft is rotatably connected to the lead screw, and a relative motion between the lead screw and at least one of the stir pin shaft or the stir sleeve shaft along the axis is locked.

10. The refill friction stir spot welding device according to claim 9, wherein the axial drive assembly includes only one hollow motor, the lead screw includes a first lead screw and a second lead screw, the lead screw nut is connected to a rotor of the only one hollow motor, the lead screw nut is provided with a first internal thread and a second internal thread, thread rotation directions of the first internal thread and the second internal thread are opposite, the first internal thread is in a driving connection with the first lead screw, and the second internal thread is in a driving connection with the second lead screw;
the stir pin shaft is rotatably connected to the first lead screw, and a relative motion between the stir pin shaft and the first lead screw along the axis is locked; and
the stir sleeve shaft is rotatably connected to the second lead screw, and a relative motion between the stir sleeve shaft and the second lead screw along the axis is locked.

11. The refill friction stir spot welding device according to claim 5, wherein the axial drive assembly includes a first hollow power cylinder and a second hollow power cylinder, central axes of both the first hollow power cylinder and the second hollow power cylinder are located on the axis, a piston rod of the first hollow power cylinder is connected to the stir pin shaft, and a piston rod of the second hollow power cylinder is connected to the stir sleeve shaft.

12. The refill friction stir spot welding device according to claim 11, wherein the stir pin shaft includes a first stir pin shaft and a second stir pin shaft, rotation axes of the first stir pin shaft and the second stir pin shaft are located on the axis, the first stir pin shaft and the second stir pin shaft are fixedly connected via a connecting rod, the stir pin is connected to the second stir pin shaft;
the connecting rod is provided with a through-slot along the direction of the axis, both the first stir pin shaft and the second stir pin shaft are provided with pin heads that match the through-slot; and
the second stir pin shaft is provided with a third cooperating structure, the stir pin is provided with a fourth cooperating structure, the third cooperating structure and the fourth cooperating structure cooperate to restrict a relative motion between the second stir pin shaft and the stir pin.

13. The refill friction stir spot welding device according to claim 12, wherein the stir sleeve shaft is sleeved outside the second stir pin shaft, rotation axes of the stir sleeve shaft and the second stir pin shaft are located on the axis, the stir sleeve shaft and the second stir pin shaft are capable of performing a relative motion along the axis, and the stir sleeve shaft and the second stir pin shaft are in a rotation-locked engagement state;
two ends of the piston rod of the first hollow power cylinder are respectively connected to the first stir pin shaft and the second stir pin shaft; and
the stir sleeve shaft is fixedly disposed inside the piston rod of the second hollow power cylinder.

14. The refill friction stir spot welding device according to claim 5, wherein the axial drive assembly includes an inner power cylinder and an outer power cylinder;
a piston rod of the inner power cylinder is connected to a first hollow slider, the first hollow slider is sleeved outside the stir pin shaft, a central axis of the first hollow slider is located on the axis, the stir pin shaft and the first hollow slider are capable of performing a rotational relative motion, a relative motion between the stir pin shaft and the first hollow slider along the axis is locked; and
a piston rod of the outer power cylinder is connected to a second hollow slider, the second hollow slider is sleeved outside the stir sleeve shaft, a central axis of the second hollow slider is located on the axis, the stir sleeve shaft and the second hollow slider are capable of performing a rotational relative motion, a relative motion between the stir sleeve shaft and the second hollow slider along the axis is locked.

15. The refill friction stir spot welding device according to claim 14, wherein there are at least two inner power cylinders, the at least two inner power cylinders are distributed around the axis as a center, there are at least two outer power cylinders, and the at least two outer power cylinders are distributed around the axis as the center.

16. The refill friction stir spot welding device according to claim 2, wherein the rotary drive assembly includes an electric spindle, a core shaft is disposed in the electric spindle and sleeved outside the stir pin shaft, rotation axes of the core shaft and the stir pin shaft are located on the axis, the core shaft and the stir pin shaft are capable of performing a relative motion along the axis, and the core shaft and the stir pin shaft are in a rotation-locked engagement state.

17. The refill friction stir spot welding device according to claim 1, further comprising: a pressing sleeve, wherein a lower portion of the pressing sleeve is provided with an opening, at least portion of the stir sleeve is movably disposed in the opening along the axis, a surface roughness of a contact surface between the stir sleeve and the pressing sleeve is less than 0.08 μm, and a surface roughness of a contact surface between the stir sleeve and the stir pin is less than 0.08 μm.

18. The refill friction stir spot welding device according to claim 1, further comprising: a processor, a force sensor, a torque sensor, an infrared thermal camera, and an image acquisition device, wherein the processor is communicatively connected to the force sensor, the torque sensor, the infrared thermal camera, and the image acquisition device, the force sensor is configured to acquire force data, the torque sensor is configured to acquire torque data, the infrared thermal camera is configured to acquire thermal imaging data, and the image acquisition device is configured to acquire a weld image; and
the processor is configured to:
determine a first welding parameter based on a material property and dimensional information of a workpiece to be welded;
control the axial drive assembly and the rotary drive assembly to weld the workpiece to be welded based on the first welding parameter;
determine a welding quality during a welding process based on the force data, the torque data, the thermal imaging data, and the weld image; and
determine a second welding parameter based on the welding quality, and control the axial drive assembly and the rotary drive assembly to weld the workpiece to be welded based on the second welding parameter.

19. The refill friction stir spot welding device according to claim 18, wherein the processor is further configured to:
determine a material flow trend based on the first welding parameter, the thermal imaging data, and the weld image; and
determine the second welding parameter based on the material flow trend and the welding quality.

20. A welding system, comprising two refill friction stir spot welding devices, a processing unit, and two robotic arms, wherein the two refill friction stir spot welding devices are respectively mounted on the two robotic arms, wherein
each of the two refill friction stir spot welding devices includes:
a stir pin assembly including a stir pin;
a stir sleeve assembly including a stir sleeve, the stir sleeve being sleeved outside the stir pin, the stir sleeve having a same axis as the stir pin; and
an axial drive assembly and a rotary drive assembly, the axial drive assembly driving the stir pin and the stir sleeve, respectively, to move along the axis, the rotary drive assembly driving the stir pin and the stir sleeve to perform a rotational motion centered on the axis, a center axis of the axial drive assembly and a rotary axis of the rotary drive assembly are both located on the axis; wherein
the two refill friction stir spot welding devices have different rotary drive assemblies, and/or
the two refill friction stir spot welding devices have different axial drive assemblies; and
the processing unit is configured to:
determine a target robotic arm based on a historical welding quality, a material property, and dimensional information of a workpiece to be welded, and control the target robotic arm to weld the workpiece to be welded.
